(19) United States
(12) Patent Application Publication
(10) Pub. No.: US 2025/0371342 A1
(43) Pub. Date: Dec. 4, 2025

(54) HANDLING MISSING DATA WITH MULTI-DOMAIN GRAPH-GUIDED NETWORKS

(71) Applicant: NEC Laboratories America, Inc., Princeton, NJ (US)

(72) Inventors: Wenchao Yu, Plainsboro, NJ (US); Haifeng Chen, West Windsor, NJ (US); Yushan Jiang, Vernon, CT (US)

(21) Appl. No.: 19/225,436

(22) Filed: Jun. 2, 2025

Related U.S. Application Data
(60) Provisional application No. 63/655,196, filed on Jun. 3, 2024.

(51) Int. Cl. G06N 3/08; B25J 9/16

(52) U.S. Cl. CPC G06N 3/08; B25J 9/163

(57) ABSTRACT

Systems and methods for handling missing data with multi-domain graph-guided networks. Graph structures can be learned with masked dimension extension based on incomplete input data obtained from monitored entities to generate inferred graphs. Time and frequency domain forecasts generated based on the inferred graphs with a variable-wise mixture mechanism can be combined to generate combined forecasts. The combined forecasts can be aligned to time and frequency domains to obtain final forecasts that capture domain-invariant similarities between variables. A corrective action generated with multi-domain graph-guided networks for the monitored entities based on the final forecasts can be performed.

### RELATED APPLICATION INFORMATION

This application claims priority to U.S. Provisional App. No. 63/655,196, filed on Jun. 3, 2024, incorporated herein by reference in its entirety.

### BACKGROUND

### Technical Field

The present invention relates to performing predictive maintenance using artificial intelligence (AI) models and more particularly to handling missing data with multi-domain graph-guided networks.

### Description of the Related Art

Autonomous system monitoring relies on accurate data obtained from sensors for monitored entities within the system. AI models can be utilized to perform predictive monitoring on the system. However, accuracy of the AI models are directly tied to the quality of training data used to train them. As such, AI models are incapable of performing accurate predictive monitoring when there are missing or inaccurate data.

### SUMMARY

According to an aspect of the present invention, a computer-implemented method for training multi-domain graph-guided networks is provided, including, learning graph structures with masked dimension extension based on incomplete input data obtained from monitored entities to generate inferred graphs, combining time and frequency domain forecasts generated based on the inferred graphs with a variable-wise mixture mechanism to generated combined forecasts, aligning the combined forecasts to time and frequency domains to obtain final forecasts that capture domain-invariant similarities between variables, and performing a corrective action generated with the multi-domain graph-guided networks for the monitored entities based on the final forecasts.

According to another aspect of the present invention, a system for training multi-domain graph-guided networks is provided, including, a memory device, one or more processor devices operatively coupled with the memory device to perform operations, learning graph structures with masked dimension extension based on incomplete input data obtained from monitored entities to generate inferred graphs, combining time and frequency domain forecasts generated based on the inferred graphs with a variable-wise mixture mechanism to generated combined forecasts, aligning the combined forecasts to time and frequency domains to obtain final forecasts that capture domain-invariant similarities between variables, and performing a corrective action generated with the multi-domain graph-guided networks for the monitored entities based on the final forecasts.

According to yet another aspect of the present invention, a non-transitory computer program product for training multi-domain graph-guided networks is provided including a computer-readable storage medium having a program code, wherein the program code when executed on a computer causes the computer to perform operations, learning graph structures with masked dimension extension based on incomplete input data obtained from monitored entities to generate inferred graphs, combining time and frequency domain forecasts generated based on the inferred graphs with a variable-wise mixture mechanism to generated combined forecasts, aligning the combined forecasts to time and frequency domains to obtain final forecasts that capture domain-invariant similarities between variables, and performing a corrective action generated with the multi-domain graph-guided networks for the monitored entities based on the final forecasts.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram showing a high-level overview of a computer-implemented method for handling missing data with multi-domain graph-guided networks, in accordance with an embodiment of the present invention;

FIG. 2 is a block diagram showing a system implementing practical applications of handling missing data with multi-domain graph-guided networks, in accordance with an embodiment of the present invention;

FIG. 3 is a block diagram showing a computer system for handling missing data with multi-domain graph-guided networks, in accordance with an embodiment of the present invention;

FIG. 4 is a block diagram showing hardware and software components of a system for handling missing data with multi-domain graph-guided networks, in accordance with an embodiment of the present invention; and

FIG. 5 is a block diagram showing a structure of deep neural networks for generating categorical data for missing values in anomaly detection systems, in accordance with an embodiment of the present invention.

### DETAILED DESCRIPTION OF PREFERRED EMBODIMENTS

In accordance with embodiments of the present invention, systems and methods are provided for handling missing data with multi-domain graph-guided networks.

In the present embodiments, graph structures can be learned with masked dimension extension based on incomplete input data obtained from monitored entities to generate inferred graphs. Time and frequency domain forecasts generated based on the inferred graphs with a variable-wise mixture mechanism can be combined to generate combined forecasts. The combined forecasts can be aligned to time and frequency domains to obtain final forecasts that capture domain-invariant similarities between variables. A corrective action generated with multi-domain graph-guided networks for the monitored entities based on the final forecasts can be performed.

Irregular multivariate time series (IMTS) forecasting, also known as multivariate time series forecasting with missing values, can be utilized to learn a model to perform the predict future values in multi-variate time-series (MTS) data, given the partially observed MTS inputs. In this setting, the acquisition of regularly sampled data is challenging due to system failures or resource constraints. As such, aside from capturing the temporal dynamics and variable interactions from the irregular data, the learned patterns to future horizons with accurate and robust forecasting results can be extrapolated by the model. In some types of spatial-temporal time series, the structural knowledge that describes the variable interactions as graphs, is available, which alleviates the irregularity issue. However, such structural knowledge in general MTS data is often implicit, making it difficult to exploit for forecasting tasks. Therefore, it is also important to learn the graph structure to tackle the multivariate nature of data to yield satisfactory forecasts and reasonable explanations. In practice, it is challenging to train a model to perform the multivariate time series forecasting task based on irregular inputs with missing values.

The present embodiments resolve these issues by learning a forecasting model with graph structure discovery from both time and frequency domain which handles missing data. The present embodiments can learn from irregular multivariate time series and capture the variable interactions to perform the underexplored and challenging forecasting task. The variable interactions in frequency domain of the MTS data can be discovered such that dominant components and distinct patterns based on Fourier analysis can complement the structural information from the time domain. Furthermore, the information from two perspectives can be mixed to generate more robust forecasts against missing values.

The present embodiments can learn the meaningful graph structures given the existence of missing information in both time domain and frequency domains, which provides variable interactions from different perspectives, including time-varying patterns of real-valued signals, and magnitude and phase patterns of complex signals.

The present embodiments can mix the forecasts generated from different domains based on a designed aggregation mechanism, which is also guided by the missing patterns. The present embodiments can leverage several regularization terms to align the time-frequency graph learning and forecasts, including an error term of frequency components and a clustering term that captures the invariant variable similarities across time and frequency domains.

There are many practical scenarios where the present invention is applicable. For example, predictive maintenance in a manufacturing plant based on the records from wireless sensor networks. Wireless sensor networks are often deployed to monitor the condition of equipment such as motors, conveyors, and pumps recording different important system parameters as MTS, such as temperature, pressure, and vibration. However, the collected MTS data can be irregular due to different data-sampling rates, sensor battery shortage, connectivity problems and other environmental interference. The model can capture the temporal dynamic of each sensor as well as the relationships between different sensors. Based on the discovered patterns, the model can generate reliable predictions of the sensor status for maintaining operational efficiency and avoiding equipment failures. This process can be performed in an end-to-end manner.

In the training stage, the forecasting model is built given the irregular sensor records (with missing values in multiple sensors), where a graph learner captures the sensor relationships based on the irregular dynamics, and a forecaster takes both the inferred graph and original data as inputs to provide predictions. The only supervised signal is the true dynamics of future sensor records. Once the model is trained, it can generate reliable and accurate forecasts of future sensor status so that the decision-making entity can perform downstream maintenance if deemed necessary based on additional rules. Moreover, the model can output a graph structure that describes the interactions between different sensors for further explanatory analysis. The present invention solves the problem in learning from irregular multivariate time series, but it can be used for regular MTS forecasting tasks without modification.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

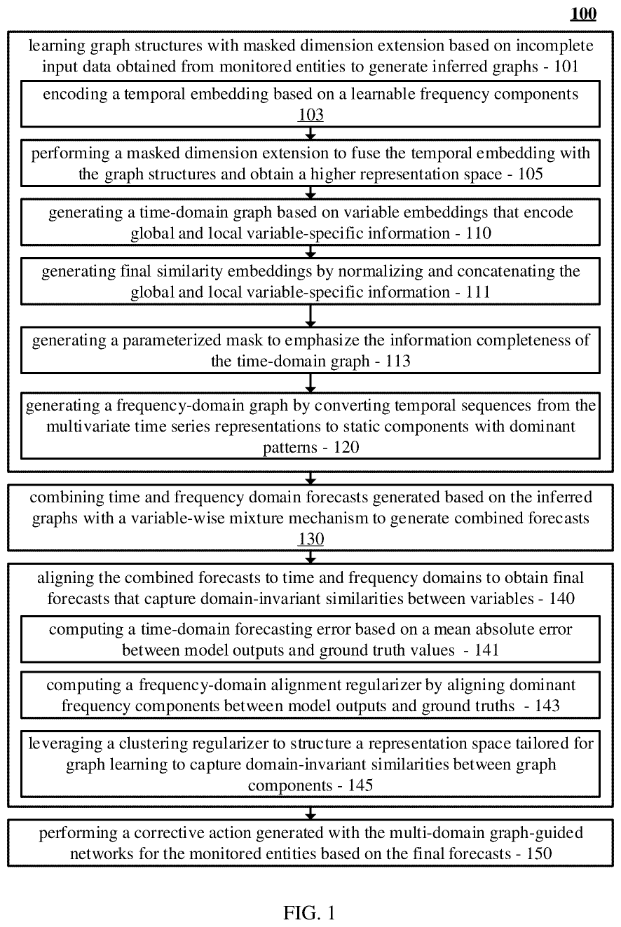

Referring now in detail to the figures in which like numerals represent the same or similar elements and initially to FIG. 1, a flow diagram showing a high-level overview of a computer-implemented method for handling missing data with multi-domain graph-guided networks, in accordance with one embodiment of the present invention.

In an embodiment, multi-domain graph guided networks can be trained to handle missing data obtained from monitored entities. Referring now to the training method for multi-domain graph guided networks to handle the missing data.

In an embodiment, graph structures can be learned with masked dimension extension based on incomplete input data obtained from monitored entities to generate inferred graphs. Time and frequency domain forecasts generated based on the inferred graphs with a variable-wise mixture mechanism can be combined to generate combined forecasts. The combined forecasts can be aligned to time and frequency domains to obtain final forecasts that capture domain-invariant similarities between variables. A corrective action generated with multi-domain graph-guided networks for the monitored entities based on the final forecasts can be performed.

In block 101, graph structures can be learned with masked dimension extension based on incomplete input data obtained from monitored entities to generate inferred graphs.

The graph structures can refer to variables, components, coefficients, matrices, etc., that are relevant to inferring graphs from the incomplete input data obtained from the monitored entities. In an embodiment, to learn the graph structures, a temporal embedding can be constructed by performing missing-aware dimension extension to the input with temporal embedding.

Let X ∈ R^{N×T} denote the IMTS data with N variables and T time steps, where X_{i,:} ∈ [symbol] denotes i-th variable and X_{:,t} ∈ [symbol] denotes t-th time step. Moreover, the missing values are indicated by a binary mask matrix M ∈ [symbol] which is defined as Mᵢⱼ=1 if xᵢⱼ is observed, otherwise 0. Based on the IMTS data with binary indicators, a deep forecasting model (f_{θ}) can be built that takes the historical window of X_{t-L:t} and M_{t-L:t} to predict the future horizon of H steps, denoted as Ŷ=X_{t;t+H}=f_{θ}(X_{t-L:t}, M_{t-L:t}).

In block 103, a temporal embedding can be encoded based on learnable frequency components.

In an embodiment, the temporal embedding Q can be encoded based on a composition of trigonometric functions with learnable frequency components, which provide meaningful periodic inductive bias to alleviate the effect of missing values in IMTS modeling of both domains with the following:

$$Q = A {Φ}_{s i n}^{T} + B {Φ}_{c o s}^{T} ∈ {ℝ}^{N \times L}$$

where A, B ∈ [symbol] are learnable coefficient matrices, Φ_{sin/cos} ∈ [symbol] are Fourier basis matrices spanned by sine and cosine functions with K frequency components of a learnable base for L time steps (K<L).

In block 105, a masked dimension extension can be performed to fuse the temporal embedding with the graph structures.

In an embodiment, to introduce more expressive representations, masked dimension extension can be performed where the available observation of each graph structure at each time step is fused with temporal embedding and lifted to a higher dimension space (d) via a multi-layer perceptron (MLP) function, which is represented as h⁰ ∈ [symbol] . The missing values can be encoded using the temporal embedding.

$${h}_{i , j}^{0} = \{ \begin{matrix}MLP ( {x}_{i , j} , {q}_{i , j} ) , {M}_{i , j} = 1 \\ MLP ( {q}_{i , j} ) , {M}_{i , j} = 0\end{matrix}$$

The inferred graphs can include the domain-specific graphs that can be learned based on the missing values. The inferred graphs can include at least a time-domain graph and frequency-domain graph.

The operational logic of a target dynamic system is characterized by the structural and temporal dependencies within underlying MTS data, which has been captured by existing deep structure learning forecasters. However, various missing patterns (missing at random, variable block missing and temporal block missing) can hinder the correct identification of structural interactions and temporal dynamics, thus compromising the effectiveness of existing methods.

To resolve this issue, in an embodiment, multi-domain graph learning can be exploited to enrich the deep representations toward accurate forecasts against different missing patterns. Each domain is modeled with n learning components, after which the representations are used to generate domain forecasts with a mixture toward the final forecast.

In block 110, a time-domain graph can be generated based on variable embeddings that encode global and local variable specific information.

In an embodiment, to generate the time-domain graph, variable embeddings U ∈ [symbol] can be designed that encode global variable specific information, where [symbol] is the set of real numbers. Global variable-specific information can include variable-specific information that are shared across different components in both time and frequency domain. As such, the embeddings coordinate the graph learning process in both domains, while facilitating the learning of global variable-specific components against missing values.

Besides the global variable-specific information, the local variable-specific representations of l th component can be extracted as V^{l} ∈ [symbol] in a data driven manner, which is done by applying a learnable convolutional kernel θ^{l} ∈ [symbol] to H. The local variable-specific information can include variable-specific information that are localized to their respective domains.

In block 111, final similarity embeddings can be generated by normalizing and concatenating the global and local variable-specific information.

In an embodiment, both global and local portions can be normalized and concatenated (denoted as ⊕) as the final similarity embeddings, that encodes the global variable-specific information, for graph structure learning for the time-domain graph, denoted as U^{l}:

$${U}^{l} = ( \frac{U ⊕ {V}^{l}}{\vert U \vert \vert {V}^{l} \vert} ) = ( \frac{U ⊕ {θ}^{l} ( {H}^{l} )}{\vert U \vert \vert {θ}^{l} ( {H}^{l} ) \vert} )$$

As such, the time-domain graph for the l th time-domain component is obtained as G=σ(U^{l}·U^{l}^{^{T}}), where σ is a scaling function (e.g., sigmoid) for bounded edge weight.

In block 113, a parameterized mask can be generated to emphasize the information completeness of the time-domain graph.

In an embodiment, as the missing pattern can serve as an inductive bias for structural modeling of irregular multivariate time series, a parameterized mask can be generated to emphasize the information completeness. In a temporal sequence, nodes with more available time steps in common are supposed to be more important, which is done by calculating the ratio of 1 s in the binary mask M_{:,t-L:t} for each row. Moreover, nodes with more observations contributes more to the edge weights, which is done by the dot product of M_{t-L:t} and its transpose. Two terms are weighted by two learnable bounded parameters from 0 to 1, to obtain a parameterized mask M′ to be applied to G via elementwise multiplications. By using the parameterized mask, a more accurate representation of G can be obtained as the parameterized mask considers missing pattern information that is specific to each input, which in turn calibrates G, resulting in more accurate forecasts.

Given the inferred graph for the time-domain, the information aggregation can be performed as follows:

$${h}_{i , t}^{l} = {ϕ}^{l} ( {h}_{i , t}^{l - 1} , S T M {P}_{k \geq 0 , j ∈ 𝒩 ( i )} ( {h}_{i , t - k}^{l - 1} , {h}_{j , t - k}^{l - 1} , {g}_{ji}^{l} ) ) ,$$

where [symbol] is the neighborhood indicated by G,

$${g}_{ji}^{l}$$

is the edge weight from node j to node i, in the 1-th block,

$${h}_{i , t - k}^{l - 1} , {h}_{j , t - k}^{l - 1}$$

are the representations of node i, j from the previous block 1-1 which covers the information of the most recent k-th time step from t, respectively, STMP denotes structural-temporal message passing that captures the neighbors in both variable and temporal dimension which can be implemented by a composition of temporal convolution with kernel size k and 1-hop graph convolution. ϕ^{l} is the temporal MLP mapping the aggregated information with a linear projected

$${h}_{i , t}^{l - 1}$$

as the residual component from the representation of node i covering the information of the most recent k-th time step from t, in the previous block 1-1.

In block 120, a frequency-domain graph can be generated by converting temporal sequences from the multivariate time series representations to static components with dominant patterns.

In an embodiment, the frequency-domain graph can be generated based on Fourier transformations between time and frequency domains. The Discrete Fourier Transform (DFT) and its inverse DFT (IDFT), can be utilized to perform conversions between time and frequency domains. As such temporal sequences can be converted to static components with dominant patterns (e.g., trend and periodicity) facilitating forecasting tasks. Given multivariate time series representations with L steps, H ∈ [symbol] , the DFT is performed along the time dimension as:

$$= {\sum }_{t = 0}^{L - 1} {H}_{: , t} {e}^{- j ( 2 π / L ) f t} , f = 0 , 1 , … , L - 1$$

where Ĥ∈ [symbol] , [symbol] is the set of complex numbers, j=\sqrt{−1} is the imaginary unit, e is Napier's constant, f denotes the frequency component in the obtained spectrum. After the frequency-domain graph-guided learning, the obtained Ĥ can be converted back to time-domain representations H via IDFT:

$${H}_{: , t} = \frac{1}{L} {\sum }_{f = 0}^{L - 1} {e}^{j ( 2 π / L ) tf} , \qquad t = 0 , 1 , … , L - 1$$

In an embodiment, conjugate symmetry can be imposed on the obtained spectrum of real-valued MTS, which reduces the number of frequency components to

$$⌊ \frac{L}{2} ⌋ + 1.$$

In the frequency domain, the graph structure can be learned in a similar manner to the time-domain graph, but based on signals with complex values. The local representation can be extracted as [symbol] = [symbol] [symbol] ∈ [symbol] . The magnitude and phase part can be modeled respectively, which can be performed with a conversion

$${V}_{m a g}^{l} = \sqrt{{Real ( \hat{{V}^{l}} )}^{2} + {Imag ( \hat{{V}^{l}} )}^{2}} , {V}_{a n g}^{l} = arc tan 2 ( \frac{Imag ( \hat{{V}^{l}} )}{Real ( \hat{{V}^{l}} )} ) ,$$

where Real and Imag denote the
real part and imaginary part of a complex signal. As such, the

$${V}_{m a g}^{l}$$

can be concatenated with U, yielding

$${G}_{mag}^{l} ,$$

where

$${G}_{a n g}^{l}$$

is constructed in the same way. The parameterized mask M′ can also be applied to both components individually. The frequency-domain graph can then represented as

$$= {G}_{m a g}^{l} \cdot exp ( - j \cdot {G}_{a n g}^{l} ) .$$

Similar to the time-domain, the information aggregation in frequency-domain can be performed as follows:

$$= ( , SSM ( , , ) )$$

Where SSMP denotes structural-spectral message passing, which can perform a 1-hop complex graph convolution sharing across all frequency components f, with a spectral MLP mapping the aggregated information with linear projected residual component in a complex plane.

In block 130, time and frequency domain forecasts generated based on the inferred graphs with a variable-wise mixture mechanism can be combined to generated combined forecasts.

In an embodiment, a mixture of variable-informed forecasts can be performed after obtaining the time-domain and frequency-domain graphs and their respective components. To reinforce the variable specific information in the forecast generation process, the final representations Hⁿ with U can be concatenated and fed into a feed-forward network (e.g., a two-layer MLP), denoted as FFN(U⊕Hⁿ). This is performed to generate both time domain and frequency domain forecasts Ŷₜᵢₘₑ ∈ [symbol] and Ŷ_{freq} ∈ [symbol] .

In an embodiment, a variable-wise mixture mechanism of time-frequency forecasts can be designed based on a mixture-of-expert design. Specifically, a weight matrix W ∈ [symbol] can be learned via multiple MLPs processing contextual information, including the mask, the input, and dual-domain forecasts, denoted as W=Sigmoid(MLPs(M, X, Ŷₜᵢₘₑ, Ŷ_{freq}). As such, the final forecast is a convex combination of two domain forecasts for each variable:

$$\hat{Y} = W ⊙ {\hat{Y}}_{t i m e} + ( 1 - W ) ⊙ {\hat{Y}}_{f r e q}$$

In block 140, the combined forecasts can be aligned to time and frequency domains to obtain final forecasts that capture domain-invariant similarities between variables.

In an embodiment, the learning objectives that aligns the forecast from both structural and temporal perspectives in dual domains can include a time-domain forecasting error, the frequency-domain alignment regularizer, and a clustering regularizer: [symbol] = [symbol] +λ [symbol] +β [symbol] , where λ and β are hyper-parameters enforcing different regularization strength.

In block 141, a time-domain forecasting error can be computed based on a mean absolute error between model outputs and ground truth values. In an embodiment, the first term [symbol] can be the main learning objective, the mean absolute error between the model outputs Ŷ and the ground truth values Y:

$${ℒ}_{Time} ( Y , \hat{Y} ) = \frac{1}{N} {\sum }_{i = 0}^{N - 1} ‖ {\hat{Y}}_{i} - {Y}_{i} ‖$$

In block 143, a frequency-domain alignment regularizer can be computed by aligning dominant frequency components between model outputs and ground truths. In an embodiment, the second term [symbol] enforces the forecasting accuracy in Fourier space, which aligns the dominant frequency components between model outputs and ground truths by minimizing the mean absolute error of Fourier coefficients:

$${ℒ}_{F r e q} ( Y , \hat{Y} ) = \frac{1}{N} {\sum }_{i = 0}^{N - 1} ‖ FFT ( {\hat{Y}}_{i} ) - F F T ( {Y}_{i} ) ‖ ,$$

where FFT is fast Fourier Transform.

As such, the temporal dynamics of the model outputs are aligned from both time and frequency domain supervised signals, yielding more robust final forecasts against irregular MTS inputs.

In block 145, a clustering regularizer can be leveraged to structure a representation space tailored for graph learning to capture domain-invariant similarities between graph components.

In an embodiment, the clustering regularizer [symbol] can be leveraged to structure the representation space tailored for graph learning, which is implemented based on the formulation in deep K-means. Other clustering methods can be used such as Deep Embedding Clustering (DEC), etc. In addition to the local variable embedding U, there is a learnable centroid embedding C ∈ R^{K×d}^{ᵤ} with K<<N and a cluster membership matrix [symbol] ∈ R^{N×K},

$${ℒ}_{C l u s t e r} = {E}_{M} [ {\vert U - ℳ C \vert}_{2} ]$$

where each row of [symbol] is the approximated categorical distribution for a variable based on Gumbel-SoftMax reparameterization trick. By minimizing the distance between variable and centroid embeddings, a clustering structure in the latent space is enforced to inform the structure learning process in both time and frequency domain, which captures the domain-invariant similarities between variables and provides global alignments across the graphs from different time-frequency blocks.

In block 150, performing a corrective action generated with the multi-domain graph-guided networks for the monitored entities based on the final forecasts.

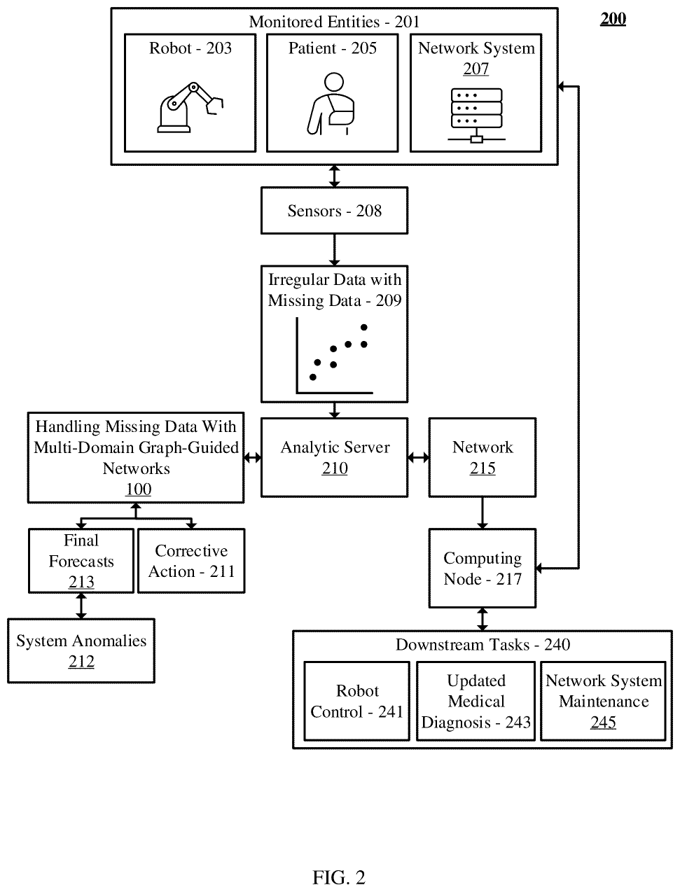

There are many practical scenarios where the present invention is applicable. For example, predictive maintenance can be performed in a manufacturing plant based on the records from wireless sensor networks. Wireless sensor networks are often deployed to monitor the condition of equipment such as motors, conveyors, and pumps recording different important system parameters as MTS, such as temperature, pressure, and vibration. However, the collected MTS data can be irregular due to different data-sampling rates, sensor battery shortage, connectivity problems and other environmental interference. The model can capture the temporal dynamic of each sensor as well as the relationships between different sensors. Based on the discovered patterns, the model can provide reliable predictions of the sensor status for maintaining operational efficiency and avoiding equipment failures. This can be done in an end-to-end manner. This is shown in more detail in FIG. 2.

Referring now to FIG. 2, a block diagram showing a system implementing practical applications of handling missing data with multi-domain graph-guided networks, in accordance with an embodiment of the present invention.

In system 200, monitored entities 201 can include a robot 203, patient 205, and network system 207. Sensors 208 can obtain irregular data with missing data 209 from the monitored entities 201. The irregular data with missing data 209 can be transmitted to an analytic server 210 that can implement handling missing data with multi-domain graph-guided networks 100. The analytic server 210 can generate forecasts 213 and corrective action 211 for downstream tasks 240 based on the irregular data with missing data 398. The forecasts 213 can include system anomalies 212. The forecasts 213 and corrective action 211 can be sent to computing nodes 217 through a network 215 to perform downstream tasks 240. The downstream tasks 240 can include robot control 241, medical diagnosis update 243, and network system maintenance 245.

In an embodiment, robot control 241, predictive maintenance can be performed based on irregular data with missing data 209 obtained from sensors 208 of a robot 203 for a manufacturing plant can be processed to determine performance metrics of the robot 203. The performance metrics can include physical metrics (e.g., temperature, humidity, etc.), workflow metrics (e.g., stage within processing workflow, etc.). Based on the irregular data with missing data 209, system anomalies 212 (e.g., sudden change in physical metrics, workflow metrics, etc.) can be detected from the final forecasts. Based on the system anomalies 212, a corrective action 211 can include generating instruction code to control the robot 203 such as stopping the robot, starting a different workflow stage, resuming the robot, etc.

In another embodiment, medical diagnosis update 243, irregular data with missing data 209 obtained from sensors 208 (e.g., electrocardiogram, sphygmomanometer, oxygen sensors, etc.) for a patient 205 can be processed to determine the overall health of the patient 205. The overall health can include health metrics such as heart rate, blood pressure, oxygen saturation, etc. However, the data obtained from the sensors 208 can include missing data as a result of missing electronic health data records, uncalibrated sensors, etc. which results to irregular data with missing data 209. Based on the irregular data with missing data 209, system anomalies 212 (e.g., illnesses such as arrythmias, hypertension, asthma, etc.) can be detected and a corrective action 211 (e.g., medical treatment such as medicine for hypertension, asthma, etc.) can be administered autonomously to the patient 205 through robotics. Additionally, a medical diagnosis can be updated based on the system anomalies 212 and the corrective action 211.

In another embodiment, network system maintenance 245, irregular data with missing data 209 obtained from sensors 208 of a network system 207 can be processed to determine performance metrics of the network system 207. The performance metrics can include physical metrics of the physical network (e.g., temperature, humidity, etc.), workflow metrics (e.g., stage within processing workflow performed by the distributed computing system, etc.). Based on the irregular data with missing data 209, system anomalies 212 (e.g., sudden change in physical metrics, workflow metrics, etc.) can be detected. Based on the system anomalies 212, a corrective action 211 can include generating instruction code to update configuration settings of the network system 207 such as adding more processing power, adding more container nodes to the network system, blocking packets from incoming IP address detected that caused the system anomaly within a distributed computing system, etc.

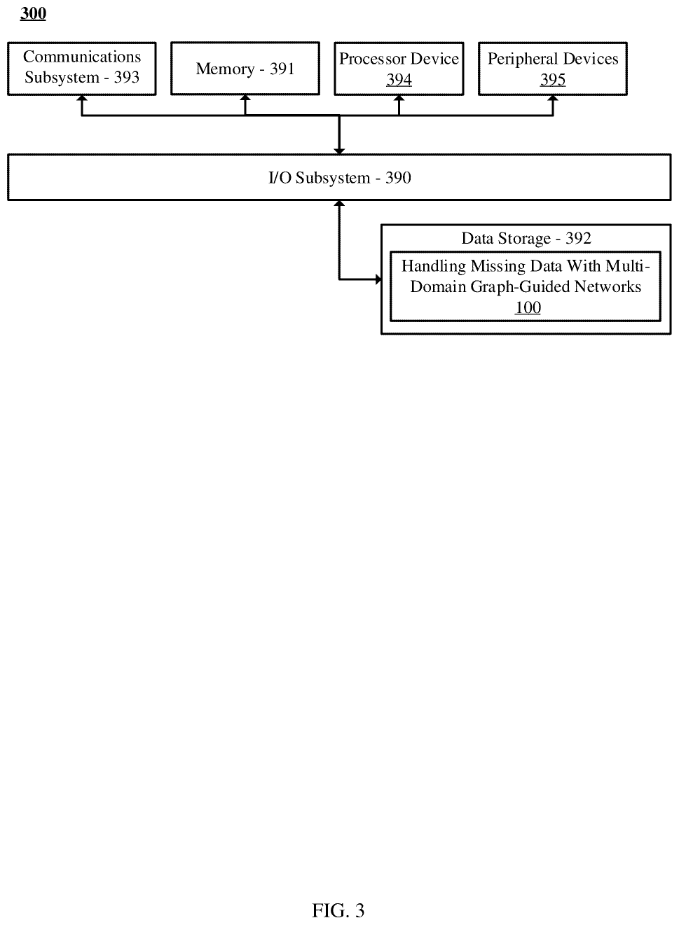

Referring now to FIG. 3, a block diagram showing a computer system for handling missing data with multi-domain graph-guided networks, in accordance with an embodiment of the present invention.

The computing device 300 illustratively includes the processor device 394, an input/output (I/O) subsystem 390, a memory 391, a data storage device 392, and a communication subsystem 393, and/or other components and devices commonly found in a server or similar computing device. The computing device 300 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 391, or portions thereof, may be incorporated in the processor device 394 in some embodiments.

The processor device 394 may be embodied as any type of processor capable of performing the functions described herein. The processor device 394 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 391 may be embodied as any type of volatile or non-volatile memory or data storage capable of performing the functions described herein. In operation, the memory 391 may store various data and software employed during operation of the computing device 300, such as operating systems, applications, programs, libraries, and drivers. The memory 391 is communicatively coupled to the processor device 394 via the I/O subsystem 390, which may be embodied as circuitry and/or components to facilitate input/output operations with the processor device 394, the memory 391, and other components of the computing device 300. For example, the I/O subsystem 390 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 390 may form a portion of a system-on-a-chip (SOC) and be incorporated, along with the processor device 394, the memory 391, and other components of the computing device 300, on a single integrated circuit chip.

The data storage device 392 may be embodied as any type of device or devices configured for short-term or long-term storage of data such as, for example, memory devices and circuits, memory cards, hard disk drives, solid state drives, or other data storage devices. The data storage device 392 can store program code for handling missing data with multi-domain graph-guided networks 100. Any or all of these program code blocks may be included in a given computing system.

The communication subsystem 393 of the computing device 300 may be embodied as any network interface controller or other communication circuit, device, or collection thereof, capable of enabling communications between the computing device 300 and other remote devices over a network. The communication subsystem 393 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 300 may also include one or more peripheral devices 395. The peripheral devices 395 may include any number of additional input/output devices, interface devices, and/or other peripheral devices. For example, in some embodiments, the peripheral devices 395 may include a display, touch screen, graphics circuitry, keyboard, mouse, speaker system, microphone, network interface, and/or other input/output devices, interface devices, GPS, camera, and/or other peripheral devices.

Of course, the computing device 300 may also include other elements (not shown), as readily contemplated by one of skill in the art, as well as omit certain elements. For example, various other sensors, input devices, and/or output devices can be included in computing device 300, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 300 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

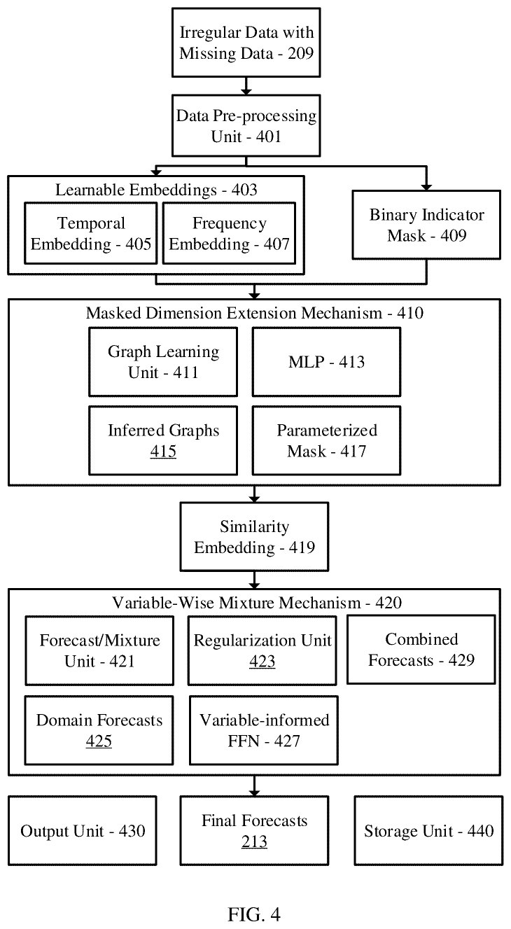

Referring now to FIG. 4, a block diagram showing hardware and software components of a system for handling missing data with multi-domain graph-guided networks, in accordance with an embodiment of the present invention.

The multi-domain graph guided networks can include a data-preprocessing unit 401, a masked dimension extension mechanism 410, a variable-wise mixture mechanism 420, an output unit 430 and a storage unit 440.

Irregular Data with missing data 209 can be pre-processed by the data pre-processing unit 401 to obtain learnable embeddings 403 and binary indicator mask 409. The learnable embeddings 403 can include temporal embedding 405 and frequency embedding 407. The learnable embeddings 403 can include the graph components.

The learnable embeddings 403 and the binary indicator mask 409 can be processed through the masked dimension extension mechanism 410. The masked dimension extension mechanism 410 can include a graph learning unit 411 that can learn inferred graphs 415 by utilizing a MLP 413, domain-wise message passing, and a parameterized mask 417. The masked dimension extension mechanism 410 can generate a similarity embedding 419 for the inferred graphs 415. The inferred graphs 415 can include the time-domain and frequency-domain graphs.

The similarity embeddings 419 can be processed by the variable-wise mixture mechanism 420 to generate final forecasts 213. The variable-wise mixture mechanism 420 can include a forecast/mixture unit 421 that utilizes the similarity embeddings 419 to generate domain forecasts 425, which includes a time-domain and frequency-domain forecasts. The forecasts/mixture unit 421 can utilize the domain forecasts 425 to generate combined forecasts 429. The regularization unit 423 computes the regularizers and the loss functions to train the variable-informed feed-forward network (FFN) 427.

The outputs of the data pre-processing unit 401, masked dimension extension mechanism 410, and the variable-wise mixture mechanism 420 can be saved in the storage unit 440. The final forecasts 213 and other outputs can be shown to a decision-making entity by utilizing the output unit 430.

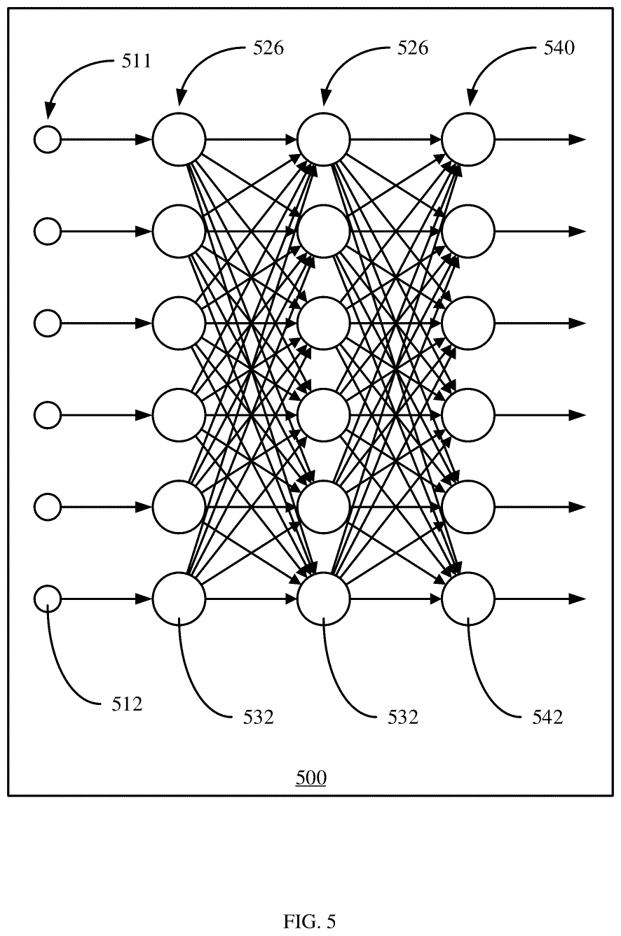

Referring now to FIG. 5, a block diagram showing a structure of deep neural networks for generating categorical data for missing values in anomaly detection systems, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . . wₙ₋1, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the MLP 413 can learn relationships between irregular data with missing data 209, binary indicator mask 409, learnable embeddings 403 to determine graph components of the inferred graphs 415. The output layer 542 can then generate a prediction of the graph components of the inferred graphs 415. In an embodiment, the computation layers 526 of the variable-informed FFN 427 can learn relationships between irregular data with missing data 209 and similarity embeddings 419 to determine components of the domain forecasts 425, combined forecasts 429, and final forecasts 213. The output layer 542 of the variable-informed FFN 427 can then generate a prediction of the domain forecasts 425, the combined forecasts 429, and final forecasts 213.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training multi-domain graph-guided networks, comprising:
learning graph structures with masked dimension extension based on incomplete input data obtained from monitored entities to generate inferred graphs;
combining time and frequency domain forecasts generated based on the inferred graphs with a variable-wise mixture mechanism to generated combined forecasts;
aligning the combined forecasts to time and frequency domains to obtain final forecasts that capture domain-invariant similarities between variables; and
performing a corrective action generated with the multi-domain graph-guided networks for the monitored entities based on the final forecasts.

2. The computer-implemented method of claim 1, wherein learning the graph structures further comprises encoding a temporal embedding based on a learnable frequency components.

3. The computer-implemented method of claim 2, wherein learning the graph structures further comprises performing the masked dimension extension to fuse the temporal embedding with the graph structures and obtain a higher representation space.

4. The computer-implemented method of claim 1, wherein learning the graph structures further comprises generating a time-domain graph based on variable embeddings that encode global and local variable-specific information.

5. The computer-implemented method of claim 4, wherein learning the graph structures further comprises generating final similarity embeddings by normalizing and concatenating the global and local variable-specific information.

6. The computer-implemented method of claim 4, wherein learning the graph structures further comprises generating a parameterized mask to emphasize information completeness of the time-domain graph.

7. The computer-implemented method of claim 4, wherein learning the graph structures further comprises generating a frequency-domain graph by converting temporal sequences from multivariate time series representations to static components with dominant patterns.

8. The computer-implemented method of claim 1, wherein aligning the combined forecasts further comprises computing a time-domain forecasting error based on a mean absolute error between model outputs and ground truth values.

9. The computer-implemented method of claim 1, wherein aligning the combined forecasts further comprises computing a frequency-domain alignment regularizer by aligning dominant frequency components between model outputs and ground truths.

10. The computer-implemented method of claim 1, wherein aligning the combined forecasts further comprises leveraging a clustering regularizer to structure a representation space tailored for graph learning to capture domain-invariant similarities between graph components.

11. The computer-implemented method of claim 1, wherein the corrective action further comprises generating instruction code to control a robot based on the final forecasts and performance metrics of the robot.

12. A system for training multi-domain graph-guided networks, comprising:
a memory device;
one or more processor devices operatively coupled with the memory device to perform operations:
learning graph structures with masked dimension extension based on incomplete input data obtained from monitored entities to generate inferred graphs;
combining time and frequency domain forecasts generated based on the inferred graphs with a variable-wise mixture mechanism to generated combined forecasts;
aligning the combined forecasts to time and frequency domains to obtain final forecasts that capture domain-invariant similarities between variables; and
performing a corrective action generated with the multi-domain graph-guided networks for the monitored entities based on the final forecasts.

13. The system of claim 12, wherein learning the graph structures further comprises encoding a temporal embedding based on a learnable frequency components.

14. The system of claim 12, wherein learning the graph structures further comprises generating a time-domain graph based on variable embeddings that encode global and local variable-specific information.

15. The system of claim 12, wherein aligning the combined forecasts further comprises computing a time-domain forecasting error based on a mean absolute error between model outputs and ground truth values.

16. The system of claim 12, wherein aligning the combined forecasts further comprises computing a frequency-domain alignment regularizer by aligning dominant frequency components between model outputs and ground truths.

17. The system of claim 12, wherein aligning the combined forecasts further comprises leveraging a clustering regularizer to structure a representation space tailored for graph learning to capture domain-invariant similarities between graph components.

18. The system of claim 12, wherein the corrective action further comprises generating instruction code to control a robot based on the final forecasts and performance metrics of the robot.

19. A non-transitory computer program product for training multi-domain graph-guided networks comprising a computer-readable storage medium including a program code, wherein the program code when executed on a computer causes the computer to perform operations:
learning graph structures with masked dimension extension based on incomplete input data obtained from monitored entities to generate inferred graphs;
combining time and frequency domain forecasts generated based on the inferred graphs with a variable-wise mixture mechanism to generated combined forecasts;
aligning the combined forecasts to time and frequency domains to obtain final forecasts that capture domain-invariant similarities between variables; and
performing a corrective action generated with the multi-domain graph-guided networks for the monitored entities based on the final forecasts.

20. The non-transitory computer program product of claim 19, wherein the corrective action further comprises generating instruction code to control a robot based on the final forecasts and performance metrics of the robot.
